(19) United States
(12) Patent Application Publication
(10) Pub. No.: US 2018/0234248 A1
(43) Pub. Date: Aug. 16, 2018

(54) COMMUNICATION SYSTEM, VEHICLE, AND MONITORING METHOD

(71) Applicant: Panasonic Intellectual Property Management Co., Ltd., Osaka (JP)

(72) Inventors: YOSHIHARU IMAMOTO, Kanagawa (JP); JUN ANZAI, Kanagawa (JP); KAZUYA FUJIMURA, Kanagawa (JP); MASATO TANABE, Aichi (JP); KOUJI KOBAYASHI, Kanagawa (JP); FEIYU CHEN, Tokyo (JP)

(21) Appl. No.: 15/877,491

(22) Filed: Jan. 23, 2018

(30) Foreign Application Priority Data
Feb. 16, 2017 (JP) 2017-027281

(51) Int. Cl. H04L 9/32; H04L 29/06

(52) U.S. Cl. CPC H04L 9/3242; H04W 4/48; H04L 63/08; H04L 63/0428

(57) ABSTRACT

A communication system includes a first electronic device, and a second electronic device that monitors a state of the first electronic device. The first electronic device includes a transmitter that transmits a first frame including a first verification value forming a Hash chain to a bus network. The second electronic device includes a storage unit that stores the first verification value included in the first frame received from the bus network. The transmitter transmits, after transmission of the first frame, a second frame including a second verification value forming the Hash chain to the bus network. The second electronic device further includes a determination unit that determines that the state of the first electronic device is normal when the second verification value included in the second frame received from the bus network and the first verification value stored in the storage unit construct the Hash chain.

The present application claims the benefit of foreign priority of Japanese patent application 2017-027281 filed on Feb. 16, 2017, the contents all of which are incorporated herein by reference.

### BACKGROUND

### 1. Technical Field

The present disclosure relates to a data processing technique, and particularly relates to a communication system, a vehicle, and a monitoring method.

### 2. Description of the Related Art

In recent years, a vehicle is mounted with a lot of electronic control units (hereinafter referred to as ECUs). A network that connects these ECUs is called an in-vehicle network. Many standards are present for the in-vehicle network, and among them a controller area network (CAN) is widely used.

A CAN communication system that protects data transmitted/received through the CAN with a message authentication code (hereinafter referred to as MAC) is proposed (for example, see Unexamined Japanese Patent Publication No. 2013-48374).

### SUMMARY

The present disclosure provides a technique that provides preferable message authentication.

A communication system from one aspect of the present disclosure includes a first electronic device connected to a bus network, and a second electronic device that is connected to the bus network and monitors a state of the first electronic device. The first electronic device includes a transmitter that transmits a first frame including a first verification value forming a Hash chain to the bus network. The second electronic device includes a storage unit that stores the first verification value included in the first frame received from the bus network. The transmitter of the first electronic device transmits, after transmission of the first frame, a second frame including a second verification value forming the Hash chain to the bus network. The second electronic device further includes a determination unit that determines that the state of the first electronic device is normal when the second verification value included in the second frame received from the bus network and the first verification value stored in the storage unit construct the Hash chain.

A vehicle from another aspect of the present disclosure includes a first electronic device connected to an in-vehicle bus network, and a second electronic device that is connected to the in-vehicle bus network and monitors a state of the first electronic device. The first electronic device includes a transmitter that transmits a first frame including a first verification value forming a Hash chain to the in-vehicle bus network. The second electronic device includes a storage unit that stores the first verification value included in the first frame received from the in-vehicle bus network. The transmitter of the first electronic device transmits, after transmission of the first frame, a second frame including a second verification value forming the Hash chain to the in-vehicle bus network. The second electronic device further includes a determination unit that determines that the state of the first electronic device is normal when the second verification value included in the second frame received from the in-vehicle bus network and the first verification value stored in the storage unit construct the Hash chain.

A monitoring method from still another aspect of the present disclosure includes a first electronic device transmitting a first frame including a first verification value forming a Hash chain to an in-vehicle bus network. The first electronic device is connected to the in-vehicle bus network. Further, the monitoring method includes a second electronic device storing the first verification value included in the first frame received from the in-vehicle bus network into a storage unit. The second electronic device is connected to the in-vehicle bus network and monitors a state of the first electronic device. The monitoring method further includes the first electronic device transmitting, after the transmitting of the first frame, a second frame including a second verification value forming the Hash chain to the in-vehicle bus network. Further, the monitoring method includes the second electronic device determining that the state of the first electronic device is normal when the second verification value included in the second frame received from the in-vehicle bus network and the first verification value stored in the storage unit construct the Hash chain.

Any desired combinations of the above described components and modifications of the features of the present disclosure in devices, computer programs, recording media containing the computer programs, or other entities are still effective as other aspects of the present disclosure.

The present disclosure can provide suitable message authentication.

### BRIEF DESCRIPTION OF THE DRAWINGS

FIG. 1 is a diagram illustrating a configuration of a vehicle according to an exemplary embodiment;

FIG. 2 is a block diagram illustrating a functional configuration of an inspection target electronic control unit (ECU) illustrated in FIG. 1;

FIG. 3 is a diagram illustrating a procedure for generating an authenticator;

FIG. 4 is a diagram schematically illustrating data to be stored in a commitment storage unit;

FIG. 5A is a diagram illustrating an example of a frame to be output from the inspection target ECU;

FIG. 5B is a diagram illustrating an example of a frame to be output from the inspection target ECU;

FIG. 5C is a diagram illustrating an example of a frame to be output from the inspection target ECU;

FIG. 5D is a diagram illustrating an example of a frame to be output from the inspection target ECU;

FIG. 5E is a diagram illustrating an example of a frame to be output from the inspection target ECU;

FIG. 6 is a block diagram illustrating a functional configuration of a monitoring ECU illustrated in FIG. 1;

FIG. 7 is a diagram illustrating a commitment management table;

FIG. 8 is a flowchart illustrating an operation of the inspection target ECU;

FIG. 9 is a flowchart illustrating an operation of the monitoring ECU;

FIG. 10 is a sequence diagram illustrating an interaction between the inspection target ECU and the monitoring ECU;

FIG. 11 is a diagram illustrating an example of a normal frame to be output from the inspection target ECU according to a first modification;

FIG. 12A is a diagram illustrating an output example of a log from the monitoring ECU according to the first modification;

FIG. 12B is a diagram illustrating an output example of a log from the monitoring ECU according to the first modification;

FIG. 12C is a diagram illustrating an output example of a log from the monitoring ECU according to the first modification;

FIG. 13 is a diagram illustrating a procedure for generating an authenticator according to a second modification;

FIG. 14 is a diagram illustrating a commitment management table according to a third modification;

FIG. 15 is a flowchart illustrating a process for automatically generating the commitment management table;

FIG. 16 is a diagram describing duplication of a Hash chain; and

FIG. 17 is a conceptual diagram of a vehicle according to the exemplary embodiment.

### DETAILED DESCRIPTION

Prior to describing an exemplary embodiment of the present disclosure, problems found in a conventional technique will now be briefly described herein. In order to identify an electronic control unit (ECU) which transmits invalid message in a system that performs message authentication using a message authentication code (MAC), different keys need to be set for each pair of respective ECUs. Therefore, a key management cost is high.

Prior to describing a configuration according to the exemplary embodiment, an outline will be described. In the message authentication using the MAC described in Unexamined Japanese Patent Publication No. 2013-48374, an ECU which transmits an invalid message cannot be identified if different keys are not set for each pair of ECUs. Further, the message authentication using the MAC is comparatively light, but a cost for key maintenance is high.

Further, Unexamined Japanese Patent Publication No. 2014-146868 proposes a network apparatus that monitors periodic information about a message being sent through a network and detects presence of an invalid message. However, it is difficult to discriminate a valid message and an invalid message and accurately specify the invalid message, by monitoring using only the periodic information.

Therefore, a monitoring ECU according to the exemplary embodiment authenticates validity of a message transmitted from an inspection target ECU to be monitored based on a Hash chain. As a result, a normal message and an abnormal message can be discriminated with high accuracy without using key information.

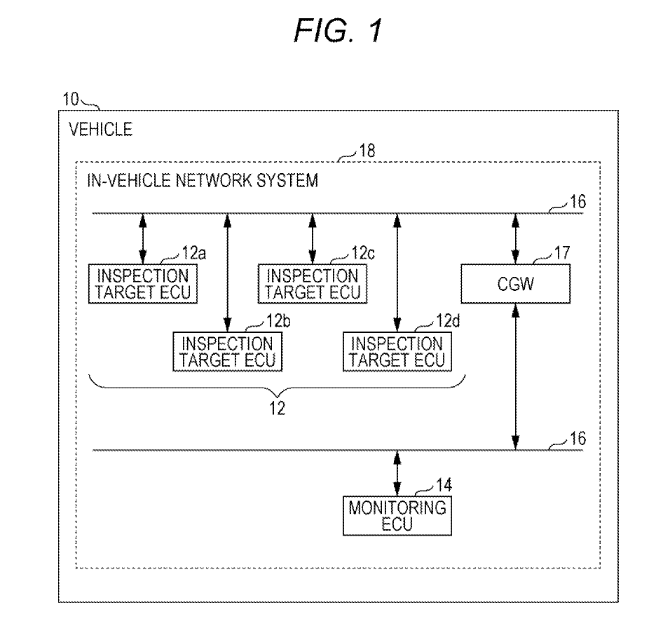

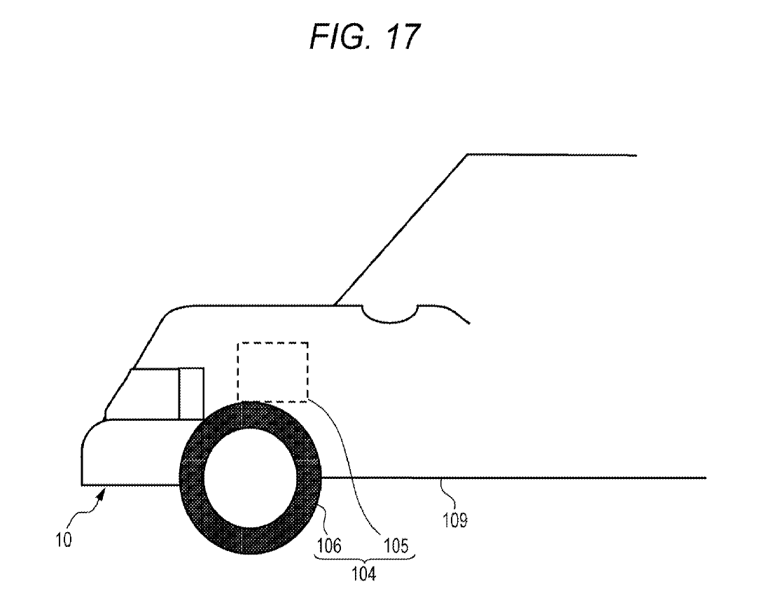

FIGS. 1 and 17 illustrate a configuration of vehicle 10 according to the exemplary embodiment. As illustrated in FIG. 17, vehicle 10 includes main body 109 and driver 104 that moves main body 109. Driver 104 includes drive source 105 such as an engine or a motor, and drive wheels 106 driven by drive source 105. FIG. 1 illustrates the configuration of vehicle 10 according to the exemplary embodiment. Vehicle 10 includes inspection target ECU 12a, inspection target ECU 12b, inspection target ECU 12c, and inspection target ECU 12d (collectively referred to as “inspection target ECU 12”), monitoring ECU 14, and central gateway (CGW) 17. Respective devices in FIG. 1 are connected via a controller area network (CAN) 16 which is an in-vehicle bus network to configure in-vehicle network system 18.

Inspection target ECU 12 is an ECU whose normality is inspected. The plurality of inspection target ECUs 12 may be, for example, an engine ECU, a brake ECU, a steering ECU, or a transmission ECU. Each inspection target ECU 12 is connected to a sensor, not illustrated, and outputs a message, which includes detection information from the sensor (also referred to as a “frame” or a “packet”, and hereinafter referred to as a “frame”), to a bus of CAN 16. Alternatively, each inspection target ECU 12 is connected to an actuator, not illustrated, and outputs a frame, which includes information about control over the actuator, to the bus of CAN 16. Details of a function of inspection target ECU 12 will be described later. For example, an engine ECU controls drive source 105 such as an engine or a motor.

Monitoring ECU 14 monitors, based on a predetermined monitoring rule, normality of a frame which is being sent through the bus of CAN 16 to monitor normality (in other words, validity) of each of the plurality of inspection target ECUs 12. Monitoring ECU 14 may be mounted as a dedicated device. Further, a monitoring module including a function of monitoring ECU 14 may be incorporated into an existing ECU (for example, an ECU of the CGW). Details of a function of monitoring ECU 14 will be described later.

In the exemplary embodiment, inspection target ECU 12 is connected to a first bus of CAN 16, and monitoring ECU 14 is connected to a second bus of CAN 16. CGW 17 relays a frame between a plurality of buses including the first bus and the second bus. CGW 17 may remove a frame having predetermined identifier (ID) at a predetermined rate for adjustment of traffic. For example, CGW 17 may relay frames, which are sent through the first bus in a cycle of 50 milliseconds, to the second bus every other time. In other words, the traffic may be adjusted by discarding a frame every other time without relay so that the cycle of the frames in the second bus is 100 milliseconds. It is not required that the first bus and the second buts are separated from each other. Inspection target ECU 12 and monitoring ECU 14 may be connected to one bus.

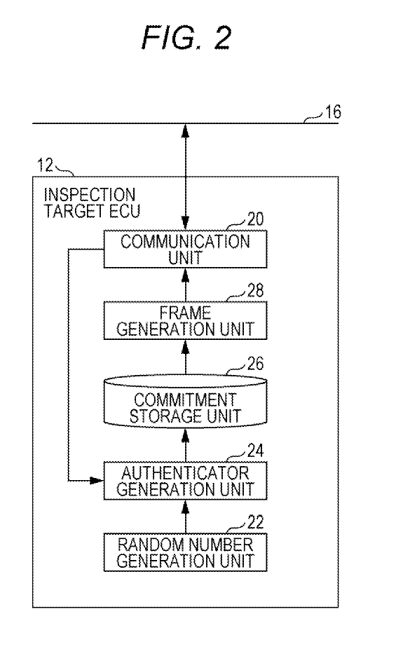

FIG. 2 is a block diagram illustrating a functional configuration of inspection target ECU 12 illustrated in FIG. 1. Inspection target ECU 12 includes communication unit 20, random number generation unit 22, authenticator generation unit 24, commitment storage unit 26, and frame generation unit 28.

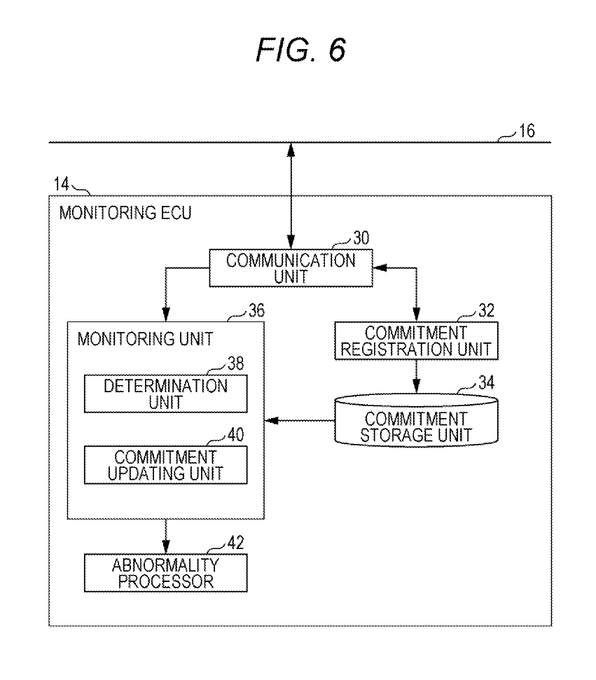

Blocks illustrated in the block diagrams of this specification can be achieved by, in terms of hardware, a central processing unit (CPU) of a computer and elements including a memory and a machine device, and in terms of software, by computer programs and other programs. Herein, functional blocks realized by cooperation of these are illustrated. It will be understood by those skilled in the art that these functional blocks can be achieved in various forms through combinations of hardware and software. For example, computer programs including modules related to the respective blocks in FIG. 2 may be stored in a memory of inspection target ECU 12. Functions of the respective blocks may be fulfilled in a manner that the CPU of inspection target ECU 12 appropriately executes the computer programs. Further, as another example, these functional blocks can also be realized as a physical circuit such as a dedicated integrated circuit (IC), a large-scale integration (LSI) circuit. The same is true on monitoring ECU 14 which will be described later with reference to FIG. 6.

Communication unit 20 receives a frame from a bus of CAN 16 in accordance with a CAN protocol. Further, communication unit 20 outputs a frame generated by frame generation unit 28 to the bus of CAN 16.

Random number generation unit 22 generates a random number sequence, which serves as original data of a Hash chain. Random number generation unit 22 may generate a random number sequence using a hardware random number generator. Further, random number generation unit 22 may generate a pseudo random number sequence through software calculation. In random number generation unit 22, accuracy can be secured by saving seeds of the random numbers in a storage. Further, random number generation unit 22 may generate a plurality of random number sequences respectively to generate a new random number sequence based on the plurality of random number sequences. This can increase entropy.

When the frame received by communication unit 20 is a commitment request frame (a frame having an ID of the commitment request frame), authenticator generation unit 24 generates an authenticator for authenticating a Hash chain, based on the random number sequence generated by random number generation unit 22. Further, when commitment updating timing comes, authenticator generation unit 24 generates a new authenticator based on the new random number sequence generated by random number generation unit 22. Authenticator generation unit 24 stores data of the generated authenticator in commitment storage unit 26.

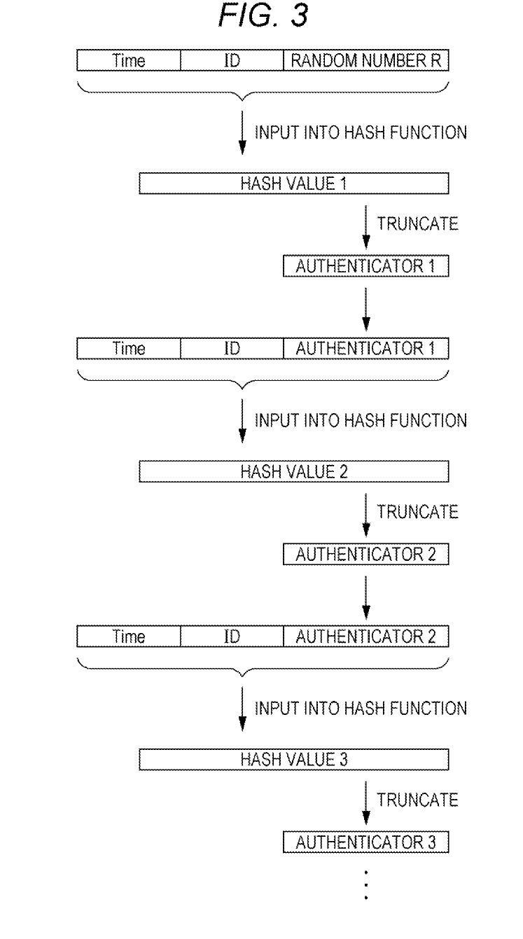

FIG. 3 illustrates a procedure for generating an authenticator. First, authenticator generation unit 24 inputs data obtained by combining a time value (Time), an ID, and a random number sequence (random number R) into a predetermined Hash function to obtain Hash value 1 output from the Hash function. Authenticator generation unit 24 truncates Hash value 1 based on a predetermined rule to obtain authenticator 1.

When registration of a commitment is requested from monitoring ECU 14, authenticator generation unit 24 uses a time value notified by monitoring ECU 14 as the time value in FIG. 3. On the other hand, when the commitment is voluntarily updated, authenticator generation unit 24 obtains a time value indicating a current time from an operating system (OS) of inspection target ECU 12 to use the time value. The time value is used as a parameter for generating an authenticator to prevent a retransmission attack. Therefore, if data has a property such that a counter value fluctuates (for example, increases), such data other than the time value can be used. Further, as the ID in FIG. 3, authenticator generation unit 24 uses a frame ID (also referred to as a message ID) which is set in a normal frame to be inspected. Further, a truncation rule may be such that higher-order or lower-order N bits (for example, 8 bits, 12 bits, 16 bits, etc.) of a Hash value are extracted.

Thereafter, authenticator generation unit 24 inputs data, which is obtained by combining authenticator 1 with a time value and an ID which are identical to the time value and ID at the time of generating Hash value 1, into the Hash function to obtain Hash value 2. Authenticator generation unit 24 truncates Hash value 2 based on the above-described rule to obtain authenticator 2. In the exemplary embodiment, an ID and a time value are synthesized with a random number or an authenticator, a Hash value of the synthesized data is obtained, and the Hash value is truncated so that a next-stage authenticator is obtained. This is one Hash operation. Authenticator generation unit 24 constructs a Hash chain by repeating the Hash operation at a predetermined number of times (for example, 999 times), and generates a plurality of authenticators (for example, authenticator 1, authenticator 2, . . . authenticator 999) in the Hash chain.

The Hash values on middle portions may possibly be identical to one other among the plurality of inspection target ECUs 12. However, since one parameter includes an ID in the Hash operation each time, even if the Hash values are once identical to one other, the Hash values thereafter are more likely to be different. In a modification, the time value and the ID in FIG. 3 may be replaced by fixed padding character strings predetermined between inspection target ECU 12 and monitoring ECU 14.

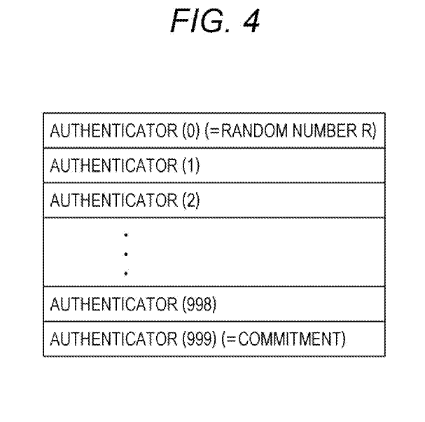

Back to FIG. 2, commitment storage unit 26 stores an authenticator generated by authenticator generation unit 24. FIG. 4 schematically illustrates data stored in commitment storage unit 26. Commitment storage unit 26 stores a plurality of authenticators generated by the Hash operation performed by authenticator generation unit 24 at a plural number of times, namely, stores authenticator (0) to authenticator (999). Authenticator (0) in FIG. 4 is a random number sequence generated by random number generation unit 22. Further, authenticator (999) in FIG. 4 is the last authenticator generated through 999 Hash operations, and is registered as a commitment in monitoring ECU 14.

First, frame generation unit 28 generates a commitment registration frame including the data of a commitment (in FIG. 4, authenticator (999)) stored in commitment storage unit 26. Frame generation unit 28 outputs the commitment registration frame to communication unit 20, and communication unit 20 transmits the commitment registration frame to monitoring ECU 14.

Thereafter, frame generation unit 28 stores identification information (a position, etc.) about a used authenticator in the authenticators stored in commitment storage unit 26. The used authenticator is, for example, an authenticator that has been set in a commitment registration frame or a normal frame. As a modification, frame generation unit 28 may store identification information about an unused authenticator. The unused authenticator is, for example, an authenticator that has not been set in the frame. In the exemplary embodiment, frame generation unit 28 stores identification information (herein, N) about the last authenticator used.

In a case where data to be delivered to an external device (another ECU or the like) such as detection information of a sensor or control information of an actuator is generated, frame generation unit 28 generates a frame including the data (hereinafter, also referred to as a “normal frame”). Frame generation unit 28 sets authenticator (N−1) in the normal frame. Authenticator (N−1) is an authenticator that is adjacent to the last authenticator used (authenticator(N)) in the unused authenticators. Frame generation unit 28 outputs the generated normal frame to communication unit 20, and communication unit 20 performs broadcast transmission of the normal frame to CAN 16.

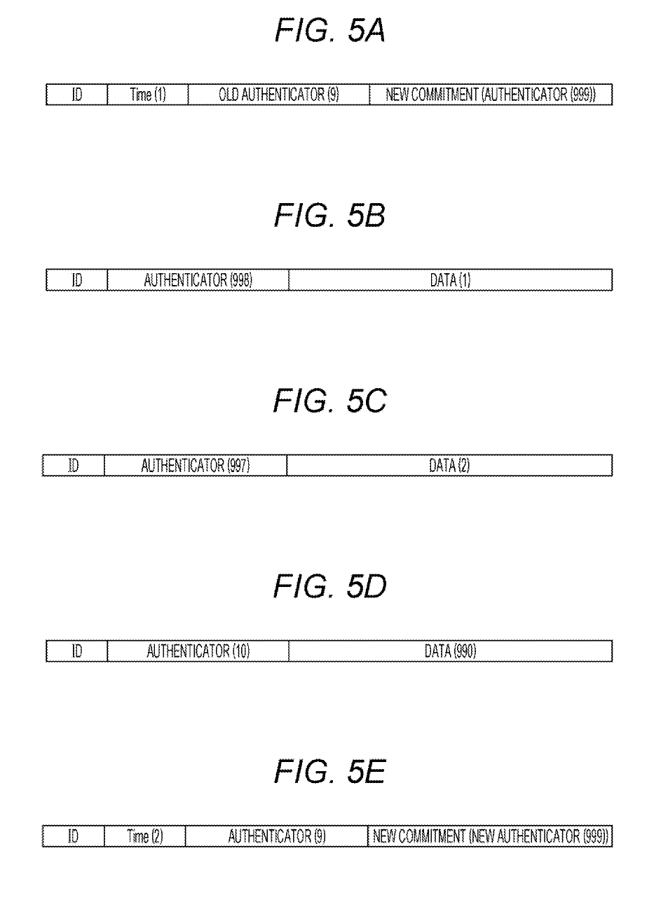

FIG. 5A to FIG. 5E illustrate examples of frames to be output form inspection target ECU 12. Herein, inspection target ECU 12 generates authenticator (0) to authenticator (999), and when using authenticators (1) to (10), reregisters a commitment based on a new Hash chain in monitoring ECU 14.

FIG. 5A illustrates a commitment registration frame. The commitment registration frame includes a frame ID of a frame to be inspected by using a commitment to be registered, a time value, an authenticator due to an earlier Hash chain (old authenticator (9)), and an authenticator due to a new Hash chain (authenticator (999)). At a time of first commitment registration, a default value (for example, “0000 . . . ”) is set in a field of an authenticator due to an earlier Hash chain.

FIG. 5B, FIG. 5C, and FIG. 5D illustrates a normal frame. The normal frame includes an ID, an authenticator, and a message text (simply, “data”) of the frame. FIG. 5B illustrates a normal frame to be transmitted next after a commitment registration frame and includes authenticator (998). FIG. 5C illustrates a normal frame to be transmitted next after the normal frame in FIG. 5B and includes authenticator (997). FIG. 5D illustrates a 990th normal frame to be transmitted and includes authenticator (10).

FIG. 5E illustrates a commitment registration frame. This commitment registration frame is transmitted next after the normal frame in FIG. 5D and is for registering a new commitment (new authenticator (999)) based on a new Hash chain. Further, the commitment registration frame in FIG. 5E includes the ID identical to the commitment registration frame in FIG. 5A, a time value different from FIG. 5A, and old authenticator (9) which is old authenticator (N−1).

FIG. 6 is a block diagram illustrating a functional configuration of monitoring ECU 14 illustrated in FIG. 1. Monitoring ECU 14 includes communication unit 30, commitment registration unit 32, commitment storage unit 34, monitoring unit 36, and abnormality processor 42. Monitoring unit 36 includes determination unit 38 and commitment updating unit 40.

Communication unit 20 receives a frame from a bus of CAN 16 in accordance with a CAN protocol. Further, communication unit 30 outputs a frame generated by monitoring ECU 14 to the bus of CAN 16.

When a predetermined condition is satisfied, for example, when monitoring ECU 14 is powered on, commitment registration unit 32 generates a commitment request frame which is a frame for requesting commitment registration. Commitment registration unit 32 outputs the commitment request frame to communication unit 30, and communication unit 30 performs broadcast transmission of the commitment request frame to CAN 16.

Further, when the frame received by communication unit 30 is a commitment registration frame (a frame having an ID of the commitment registration frame), commitment registration unit 32 saves data included in the commitment registration frame (for example, authenticator (999)) in commitment storage unit 34.

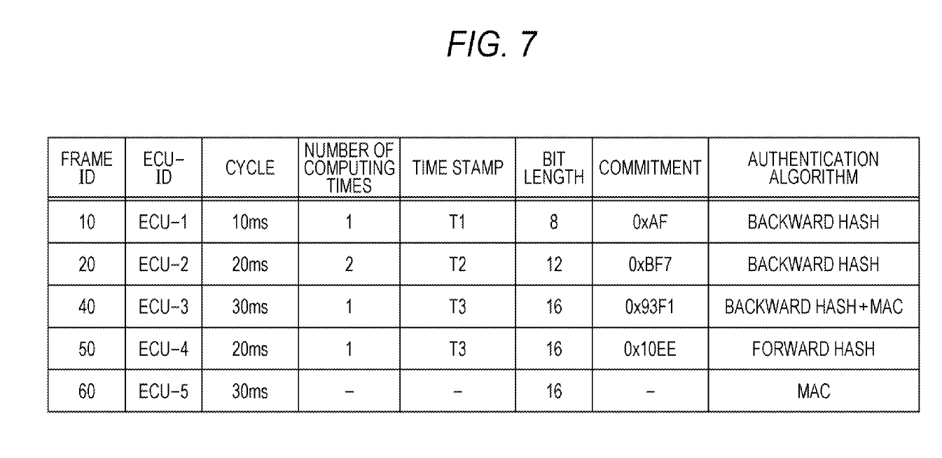

Commitment storage unit 34 stores a commitment management table. FIG. 7 illustrates the commitment management table. Commitment management table may be a table and includes a frame ID, an ECU-ID, a cycle, a number of operation times, a time stamp, a bit length, a commitment, and an authentication algorithm as a plurality of parameters. The frame ID represents an ID of a normal frame to be inspected (a message ID). The ECU-ID represents an ID of inspection target ECU 12 which is a transmission source of a normal frame. The cycle is a parameter for detecting a behavior and represents a frame reception cycle. The number of operation times represents a number of times of a Hash operation in Hash chain authentication.

The time stamp is a parameter for a countermeasure against a retransmission attack using a commitment registration frame. The bit length represents a bit length of a commitment. The authentication algorithm represents an algorithm for authenticating a normal frame. The authentication algorithm includes, for example, backward Hash, forward Hash, a MAC, or a combination of them. An amount of calculation resource of the plurality of inspection target ECUs 12 varies, and an authentication algorithm according to the amount of calculation resource can be used. As described later, a combination of the Hash chain authentication and the MAC authentication makes it possible to understand details of an abnormal state of inspection target ECU 12.

In the parameters in the commitment management table, the frame ID, the ECU-ID, the cycle, the number of operation times, and authentication algorithm are preset at a time of manufacturing vehicle 10. Alternatively, the commitment management table in which these parameter values are set may be provided from a server on a cloud to vehicle 10. It is preferable that an electronic signature of a manufacturer is provided to the commitment management table provided by the server, and only a management table whose authentication has succeeded is accepted. Commitment registration unit 32 specifies a record of the commitment management table related to the frame ID of the normal frame set in the commitment registration frame (hereinafter referred to as “correspondence rule”), and sets a time value, which is included in the commitment registration frame, in a field of the time stamp of the correspondence rule. Further, commitment registration unit 32 sets a commitment value, which is included in the commitment registration frame (for example, authenticator (999)), in the field of the commitment of the correspondence rule, and sets a length of the commitment in the field of the bit length.

When the time value included in the commitment registration frame is older than or equal to the time stamp of the correspondence rule in the commitment management table, commitment registration unit 32 determines that the commitment registration frame is a retransmission attack, and discards the commitment registration frame. That is, commitment registration unit 32 suppresses reflecting of contents of the commitment registration frame in the correspondence rule.

Further, when a result of the Hash operation based on a value of the old authenticator included in the commitment registration frame (for example, old authenticator(9) in FIG. 5A) matches a commitment value of the correspondence rule (a value before updating), commitment registration unit 32 reflects the contents of the commitment registration frame in the correspondence rule. That is, commitment registration unit 32 saves the commitment value included in the commitment registration frame as a new commitment value of the correspondence rule. As a result, invalid updating of the commitment value is prevented.

Back to FIG. 6, monitoring unit 36 monitors, based on the commitment management table stored in commitment storage unit 34, validity of a frame received by communication unit 30. Specifically, when the ID of the received frame has been recorded in the commitment management table in commitment storage unit 34, determination unit 38 identifies the received frame as a frame to be inspected, and identifies a record of the commitment management table that matches the frame ID of the frame to be inspected as the correspondence rule. Determination unit 38 checks whether the authenticator included in the frame to be inspected and the commitment value of the correspondence rule construct a Hash chain. When both the authenticator and the commitment value construct a Hash chain, determination unit 38 determines that the frame to be inspected is normal, and determines that the state of inspection target ECU 12 which is a transmission source of the frame is normal.

Authentication based on the backward Hash will be described. In a case of the backward Hash, an Nth (N is an integer of 2 or more) authenticator in the Hash chain is prerecorded as a commitment value in the commitment management table, and an N-1st authenticator in the Hash chain is specified in a frame to be inspected. Determination unit 38 inputs the authenticator included in the frame to be inspected and synthesized data of the frame ID and the time stamp in the correspondence rule into the Hash function to obtain a Hash value. Determination unit 38 obtains a value obtained by truncating the Hash value in accordance with a predetermined truncation rule as a verification value. The Hash function and the truncation rule are shared between inspection target ECU 12 and monitoring ECU 14.

That is, determination unit 38 generates authenticator (α+1) as a verification value based on an authenticator (authenticator (α)) included in a frame to be inspected. When a transmission source of the frame to be inspected is appropriate inspection target ECU 12, the verification value matches the commitment value prerecorded in the commitment management table. Therefore, when the verification value matches the commitment value of the correspondence rule, determination unit 38 determines that the frame to be inspected is normal, and determines that the state of inspection target ECU 12 which is the transmission source of the frame to be inspected is normal. In other words, when the verification value does not match the commitment value of the correspondence rule, determination unit 38 determines that the frame to be inspected is abnormal, and determines that the state of inspection target ECU 12 which is the transmission source of the frame to be inspected is abnormal.

Next, authentication based on the forward Hash will be described below. In a case of the forward Hash, an Nth (N is an integer of 1 or more) authenticator in a Hash chain is prerecorded as a commitment value in the commitment management table, and an N+1st authenticator in the Hash chain is specified in the frame to be inspected. Determination unit 38 inputs synthesized data of the frame ID, the time stamp, and the commitment value in the correspondence rule into the Hash function to obtain a Hash value. Determination unit 38 obtains a value obtained by truncating the Hash value in accordance with a predetermined truncation rule as a verification value.

That is, determination unit 38 generates authenticator (α+1) as a verification value based on authenticator (α) which is the prerecorded commitment value. When the verification value matches an authenticator included in a frame to be inspected, determination unit 38 determines that the frame to be inspected is normal, and determines that the state of inspection target ECU 12 which is the transmission source of the frame to be inspected is normal. A security level is lower in the forward Hash than in the backward Hash, but an amount of calculation in inspection target ECU 12 is smaller. For this reason, the forward Hash is preferable in a case where a calculation resource of inspection target ECU 12 is small. For example, valid inspection target ECU 12a registers a commitment in monitoring ECU 14, and accordingly continues transmitting a forward Hash chain to monitoring ECU 14. In this case, even if invalid inspection target ECU 12b spoofs inspection target ECU 12a to transmit a frame, monitoring ECU 14 recognizes that two ECUs continue transmission with the same chain and thus can detect occurrence of invalidity. The combination of the Hash chain authentication and the MAC authentication will be described in modifications.

Further, determination unit 38 measures a reception cycle of frames having a plurality of frame IDs defined in the commitment management table. Determination unit 38 determines, as detection of a behavior, that a frame, in which a difference between the measured reception cycle and the cycle in the commitment management table exceeds a predetermined range, is abnormal. Further, determination unit 38 determines that the state of inspection target ECU 12 which is the transmission source of the frame is abnormal. The detection of the behavior makes it possible to detect spoofing of an ECU.

In the number of operation times in the commitment management table, a number of times is set in accordance with a number of frames to be discarded by CGW 17 among frames transmitted by inspection target ECU 12 (for example, a rate of a frame which is not relayed between buses of CAN 16). For example, in the commitment management table in FIG. 7, since the frames having IDs “10”, “40”, and “50” are not discarded by CGW 17, the number of operation times is set to one (namely, no repetition). On the other hand, since the frame having ID “20” is discarded by CGW 17 every other time (in other words, 50% of the frames are discarded), the number of operation times is set to two.

In the case of the Backward Hash, when a result of performing the Hash operation based on an authenticator included in a frame to be inspected at the number of operation times defined by the correspondence rule matches the commitment value defined by the correspondence rule, determination unit 38 determines that the state of inspection target ECU 12 which is the transmission source of the frame to be inspected is normal. On the other hand, in the case of the forward Hash, when a result of performing the Hash operation based on the commitment value of the correspondence rule at the number of operation times defined by the correspondence rule matches the authenticator included in a frame to be inspected, determination unit 38 determines that the state of inspection target ECU 12 which is the transmission source of the frame to be inspected is normal.

In an example of the commitment management table in FIG. 7, determination unit 38 obtains a result of repeating the Hash operation based on the authenticator included in the frame having ID “20” twice as a verification value. When the verification value matches the commitment value, determination unit 38 determines that the state of inspection target ECU 12 (ECU-2) which is the transmission source of the frame having ID “20” is normal. As a result, also when CGW 17 deletes a frame, in other words, reduces a band, monitoring ECU 14 can accurately determine normality of the frame, namely, normality of inspection target ECU 12 which is the frame transmission source.

When a result of performing the Hash operation based on an authenticator included in a frame to be inspected at the number of operation times defined by the correspondence rule (herein, X times) does not match the commitment value defined by the correspondence rule, determination unit 38 may repeat the Hash operation and collate each result of each Hash operation with the commitment value. Further, a number of retry times in the Hash operation is predetermined, and frame generation unit 28 may repeat the Hash operation up to a ceiling of the number of retry times. When a result of repeating the Hash operation at a certain number of times (herein, Y times) matches the commitment value, determination unit 38 may detect that transmission of (Y-X) frames results in error in CAN 16.

For example, when a result of repeating the Hash operation on the frame having ID “10” in FIG. 7 three times matches the commitment value, determination unit 38 may determine loss of two frames having ID “10”.

Further, when a result of repeating the Hash operation on the frame having ID “20” in FIG. 7 three times matches the commitment value, determination unit 38 may determine loss of one frame having ID “20”. According to this aspect, deletion of a frame by CGW 17 and loss of a frame due to a transmission error can be discriminately detected.

After determination unit 38 determines whether a frame to be inspected is normal, commitment updating unit 40 records an authenticator included in the frame to be inspected as a new commitment value into a commitment field of the correspondence rule.

Determination unit 38 outputs at least one of a frame ID and an ECU-ID determined as being abnormal, and the determined result including abnormal contents to abnormality processor 42. Abnormality processor 42 executes a post-process according to the determined result in determination unit 38.

For example, abnormality processor 42 may record information representing the determined result in determination unit 38 in a predetermined log file. Further, abnormality processor 42 may display the information representing the determined result in determination unit 38 on a display unit of vehicle 10 (a car navigation device, a lamp of a dashboard, etc.).

Further, abnormality processor 42 may transmit information representing the determined result in determination unit 38 to a predetermined external device such as a server on a cloud. The information representing the determined result in determination unit 38 may include at least one of information representing whether a frame having a specific ID is normal, and information representing whether an ECU having a specific ID is normal. Further, this information may include a result of behavior detection based on a cycle or presence/absence of detection of a retransmission attack.

An operation of in-vehicle network system 18 having the above configuration will be described.

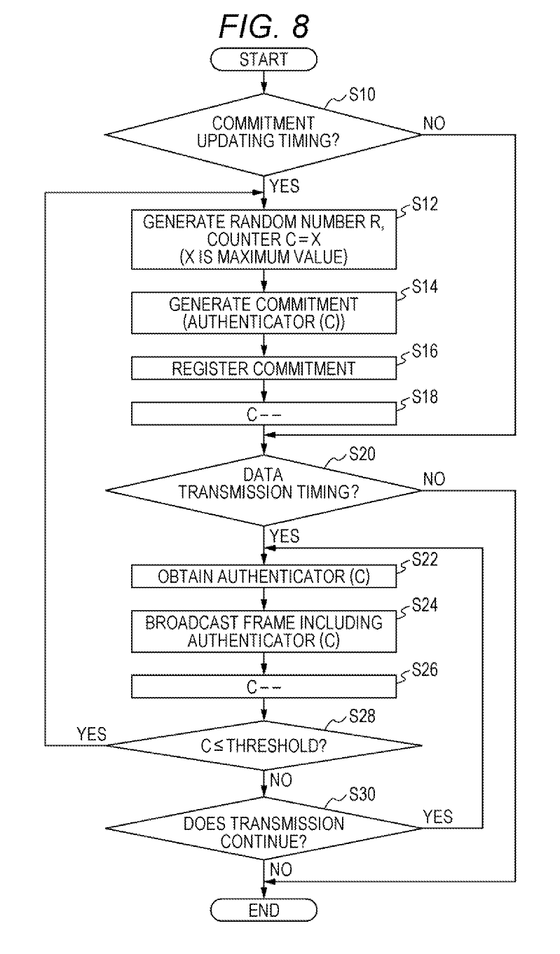

FIG. 8 is a flowchart illustrating an operation of inspection target ECU 12. If inspection target ECU 12 detects that commitment updating timing has come (Y in S10), inspection target ECU 12 executes a process for generating and registering a new commitment. The commitment updating timing comes, in the exemplary embodiment, (1) when a commitment request frame is received from monitoring ECU 14, and (2) when a predetermined number of authenticators based on an earlier Hash chain are used (for example, when authenticator (999) to authenticator (10) are used). In a modification, the process for generating and registering a new commitment may be executed when another event occurs such that the power source is switched from off to on.

Random number generation unit 22 generates a random number, and authenticator generation unit 24 sets counter C to maximum value X (herein, “999”) (S12). Authenticator generation unit 24 repeats the Hash operation based on the random number at C times, and sequentially generates authenticator (1) to authenticator (999) to save these authenticators in commitment storage unit 26 (S14). Frame generation unit 28 generates a commitment registration frame in which authenticator (999) is set as a commitment value, and communication unit 20 outputs the commitment registration frame to CAN 16 and transmits the frame to monitoring ECU 14 (S16). Frame generation unit 28 decrements counter C (S18). Counter C indicates “998” just after the transmission of the commitment registration frame. If the commitment updating timing has not come yet (N in S10), S12 to S18 are skipped.

When data to be transmitted to an external device (another ECU or the like) is generated (Y in S20), frame generation unit 28 obtains authenticator (C) (for example, authenticator (998)) from commitment storage unit 26 (S22). Frame generation unit 28 generates a normal frame in which authenticator (C) is set, and communication unit 20 broadcasts the normal frame to CAN 16 (S24). Frame generation unit 28 decrements counter C (S26). When counter C indicates a value which is a predetermined threshold (for example, “9”) or less (Y in S28), the process returns to S12, and the process for generating and registering a new commitment is executed. When counter C indicates a value larger than the threshold (N in S28) and data to be transmitted remains (Y in S30), the process returns to S22. When the transmission of the data is completed (N in S30), the flow in this drawing is ended. When the data to be transmitted to an external device is not present (N in S20), S22 to S30 are skipped. The flow in FIG. 8 is repeated during activation of inspection target ECU 12.

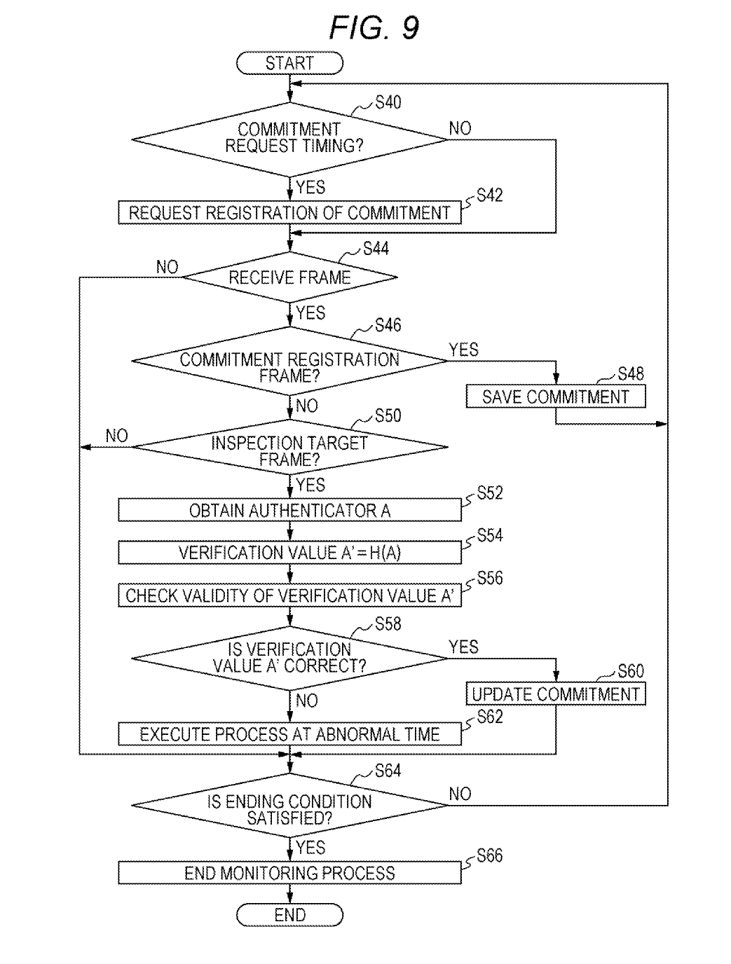

FIG. 9 is a flowchart illustrating an operation of monitoring ECU 14. If commitment request timing has come as a consequence of, for example, switching the power source from off to on (Y in S40), commitment registration unit 32 generates a commitment request frame, and communication unit 30 outputs the commitment request frame to CAN 16 to transmit the frame to inspection target ECU 12 (S42). If the commitment request timing has not come yet (N in S40), S42 is skipped. If communication unit 20 receives a frame (Y in S44) and the received frame is a commitment registration frame (Y in S46), commitment registration unit 32 associates a commitment value specified in the frame with an ID of a normal frame specified in the frame to save the commitment value in commitment storage unit 34 (S48).

If the received frame is not a commitment registration frame (N in S46) but is a frame to be inspected whose ID is registered in the commitment management table (Y in S50), determination unit 38 obtains an authenticator (herein, authenticator A) included in the frame to be inspected (S52). Determination unit 38 obtains a result of the Hash operation based on authenticator A (herein, verification value A′) (S54). Determination unit 38 compares the commitment value defined by the correspondence rule with verification value A′ to verify validity of verification value A′ (S56). When verification value A′ is valid, namely, verification value A′ matches the commitment value (Y in S58), determination unit 38 determines that the frame to be inspected is normal, namely, the state of inspection target ECU 12 which is the transmission source is normal. Determination unit 38 saves verification value A′ as a new commitment value of the correspondence rule (S60).

If verification value A′ is invalid, namely, verification value A′ does not match the commitment value (N in S58), determination unit 38 determines that the frame to be inspected is abnormal, namely, the state of inspection target ECU 12 which is the transmission source is abnormal. Abnormality processor 42 executes an abnormality process for a case where the state of inspection target ECU 12 is abnormal (for example, log output) (S62). If the received frame is not a frame to be inspected (N in S50), S52 to S62 are skipped, and if a frame is not received from CAN 16 (N in S44), S46 to S62 are skipped. If a predetermined condition such that power source is switched from on to off (Y in S64), monitoring ECU 14 ends the monitoring process in CAN 16 (S66) and ends the flow in this drawing. When the end condition is not satisfied (N in S64), the process returns to S40.

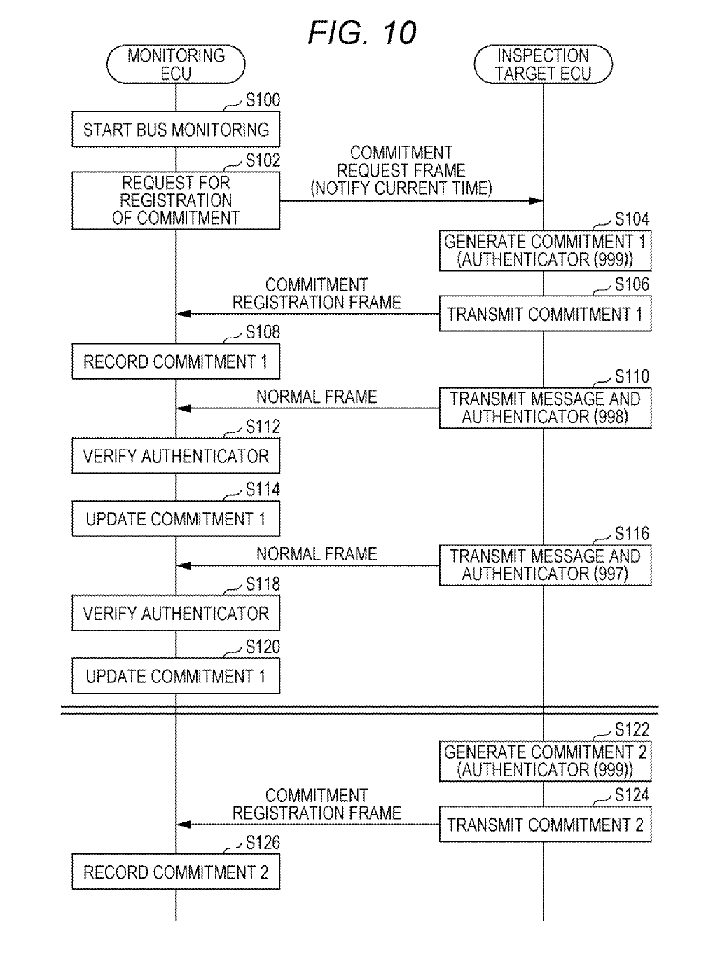

FIG. 10 is a sequence diagram illustrating an interaction between monitoring ECU 14 and inspection target ECU 12. Monitoring ECU 14 starts monitoring the bus of CAN 16 (S100), and transmits the commitment request frame including a time value representing a current time to inspection target ECU 12 (S102). Inspection target ECU 12 generates commitment 1 (authenticator (999)) based on the time value notified by a server and a random number dynamically generated (S104). Inspection target ECU 12 broadcasts a commitment registration frame including commitment 1 to CAN 16 so as to transmit the commitment registration frame to monitoring ECU 14 (S106). Monitoring ECU 14 stores commitment 1 while being associated with the ID of the normal frame transmitted by inspection target ECU 12 (S108).

Inspection target ECU 12 broadcasts, to CAN 16, a normal frame which includes authenticator (998) and a message to be transmitted to an external device (S110). Monitoring ECU 14 receives the broadcasted normal frame as a frame to be inspected. Monitoring ECU 14 checks normality of the frame to be inspected by verifying authenticator (998) (S112). When the frame to be inspected is normal, monitoring ECU 14 updates the value of commitment 1 to authenticator (998) (S114). Thereafter, inspection target ECU 12 broadcasts, to CAN 16, a normal frame, which includes authenticator (997) and a message to be transmitted to an external device (S116). Monitoring ECU 14 receives the broadcasted normal frame as a frame to be inspected. Monitoring ECU 14 checks normality of the frame to be inspected by verifying authenticator (997) (S118). When the frame to be inspected is normal, monitoring ECU 14 updates the value of commitment 1 to authenticator (997) (S120).

Thereafter, inspection target ECU 12 broadcasts the normal frame by sequentially using authenticator (996) to authenticator (10) until the commitment updating timing comes, and monitoring ECU 14 verifies the respective authenticators. When using authenticator (10), inspection target ECU 12 detects that the commitment updating timing has come, and generates new commitment 2 (authenticator (999)) based on a new Hash chain (S122). Inspection target ECU 12 broadcasts a commitment registration frame including commitment 2 to CAN 16 so as to transmit the commitment registration frame to monitoring ECU 14 (S124). Monitoring ECU 14 stores commitment 2 while being associated with the ID of the normal frame transmitted by inspection target ECU 12 (S126).

In in-vehicle network system 18 according to the exemplary embodiment, monitoring ECU 14 verifies validity of the frame to be transmitted from inspection target ECU 12 based on the Hash chain. This makes it possible to highly accurately discriminate whether the frame which is being sent through CAN 16 is normal or abnormal without using key information.

The Hash function is a one-way function, and calculation in an opposite direction requires a brute force attack. Even if an invalid person obtains a commitment registered in monitoring ECU 14 (herein, authenticator (N)), it is very difficult for the invalid person to obtain authenticator (N-D. Therefore, when verification of authenticator (N-D included in the frame to be inspected succeeds, the frame to be inspected is guaranteed to be transmitted from valid inspection target ECU 12.

Further, since an attacker does not know an input value (authenticator (N−1)) for the commitment (authenticator (N)), even if an ECU taken over by the attacker spoofs inspection target ECU 12, Hash chain authentication results in NG so that spoofing can be detected. Further, even if the attacker falsifies a commitment, monitoring ECU 14 doubly accepts commitment registration frames with the same IDs to detect falsification.

The present disclosure has been described above according to the exemplary embodiment. It will be understood by those skilled in the art that the exemplary embodiment is merely example, other modifications in which components or processes of the exemplary embodiment are variously combined are possible, and the other modifications will still fall within the scope of the present disclosure.

### (First Modification)

In a first modification, Hash chain authentication and MAC authentication are used in combination. In the normal MAC authentication, a synthetic value of a predetermined initial value (IV), a common key for a MAC, and data (a message text) is input into a Hash function for the MAC, and a Hash value output from the Hash function is used as the MAC. In the first modification, the authenticators described in the exemplary embodiment are used as the IV. That is, in the first modification, a Hash value based on a synthetic value of an authenticator, a predetermined common key, and data (a message text) is used as the MAC. The predetermined common key may be a key for each vehicle or a key shared among a plurality of ECUs in vehicle 10.

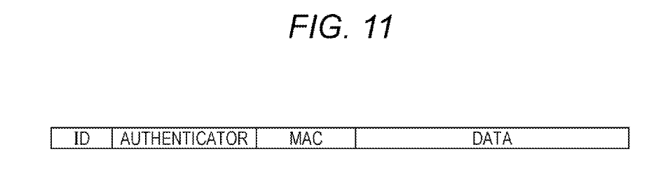

FIG. 11 illustrates an example of the normal frame output from inspection target ECU 12 according to the first modification. The normal frame according to the first modification further includes a MAC. Frame generation unit 28 of inspection target ECU 12 obtains, as the MAC, the Hash value based on the synthetic value of the authenticator, the common key for the MAC, and the data (the message text) during generation of the normal frame, and sets the obtained MAC in the normal frame. The MAC may be added to the commitment registration frame.

When receiving the normal frame transmitted from inspection target ECU 12 as the frame to be inspected, determination unit 38 of monitoring ECU 14 verifies an authenticator included in the frame to be inspected (in other words, the IV of the MAC) similarly to the exemplary embodiment. At the same time, determination unit 38 verifies the MAC included in the frame to be inspected according to a commonly-known method. For example, determination unit 38 may generate a collation value based on the authenticator, the data (the message text), and the predetermined common key included in the frame to be inspected. When the generated collation value matches the MAC included in the frame to be inspected, determination unit 38 may determine that the verification of the MAC succeeds.

When at least one of the verification using an authenticator and verification using a MAC fails, determination unit 38 specifies an invalid state in accordance with combinations of success/failure of the verification using the authenticator and success/failure of the verification using the MAC. Herein, three cases will be described as follows.

Case 1: As to a frame to be inspected transmitted from a first ECU (namely, an ID related to the first ECU is set), verification using the authenticator fails and verification using the MAC succeeds.

Case 2: As to the frame to be inspected, the verification using the authenticator fails and the verification using the MAC also fails.

Case 3: As to the frame to be inspected, the verification using the authenticator succeeds and the verification using the MAC fails.

In case 1, a second ECU taken over by an invalid person transmits a frame having the ID associated with the first ECU. In this case, determination unit 38 determines that the second ECU spoofs the first ECU and inserts a frame. In case 2, determination unit 38 determines that invalid frame (a command) is inserted from an outside of vehicle 10. Further, in case 3, determination unit 38 determines that a third party ECU is physically added. Abnormality processor 42 outputs a log representing a determined result obtained by determination unit 38 to a predetermined storage area.

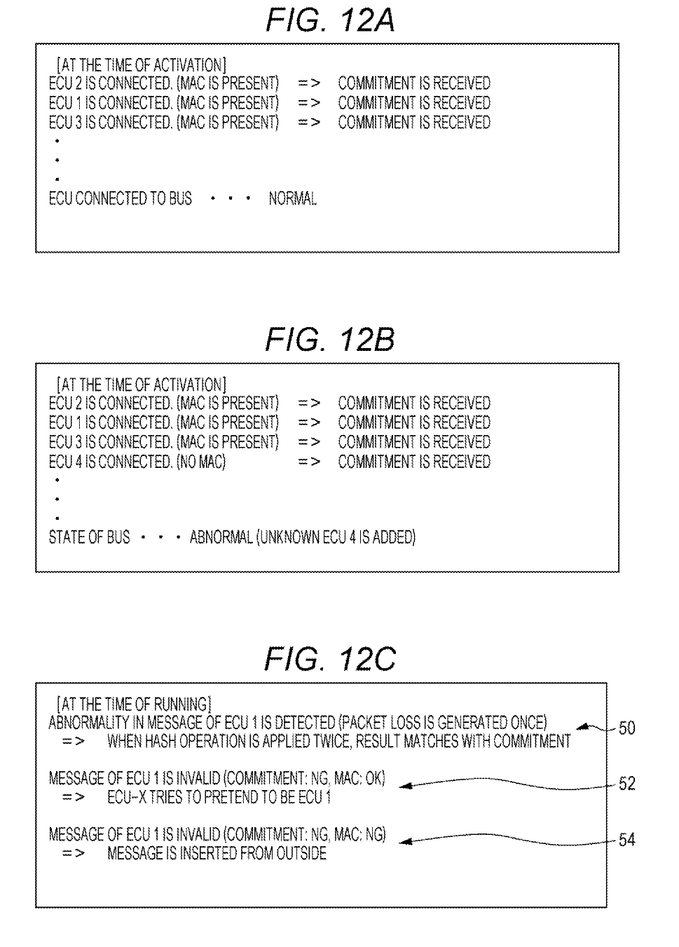

FIG. 12A to FIG. 12C illustrate output examples of the log from monitoring ECU 14 according to the first modification. FIG. 12A illustrates the log indicating a normal state at an activating time. FIG. 12B illustrates the log indicating an abnormal state at the activating time. FIG. 12A and FIG. 12B illustrate the logs output by monitoring ECU 14 when each inspection target ECU 12 registers a commitment in monitoring ECU 14 upon starting of the engine. Specifically, FIG. 12A and 12B illustrate that since a MAC is not added to a frame from ECU 4 although MACs are supposed to be added to all frames, a determination is made that the state is abnormal.

FIG. 12C illustrates the log indicating an abnormal state at a traveling time. Log 50 indicates that loss of a frame described in the exemplary embodiment is detected. Log 52 indicates that since the verification using the authenticator fails and the verification using the MAC succeeds, it is detected that a certain ECU spoofs another ECU. Log 54 indicates that since the verification using the authenticator fails and the verification using the MAC also fails, it is detected that an invalid frame is externally inserted.

According to the modification 1, details of an abnormal state can be understood by using both the Hash chain authentication and the MAC authentication. Further, even when a MAC key is a key for each vehicle, a transmission source can be identified by the Hash chain authentication. Further, in order to identify a transmission source, a key does not have to be prepared for each pair of ECUs. As illustrated in FIG. 12A and FIG. 12B, in the first modification, a valid ECU transmits a frame having a MAC. On the other hand, in the above exemplary embodiment, even when a MAC is not added to a frame, monitoring ECU 14 can detect, as abnormality, that a predetermined number or more of ECUs (inspection target ECUs 12) register a commitment.

### (Second Modification)

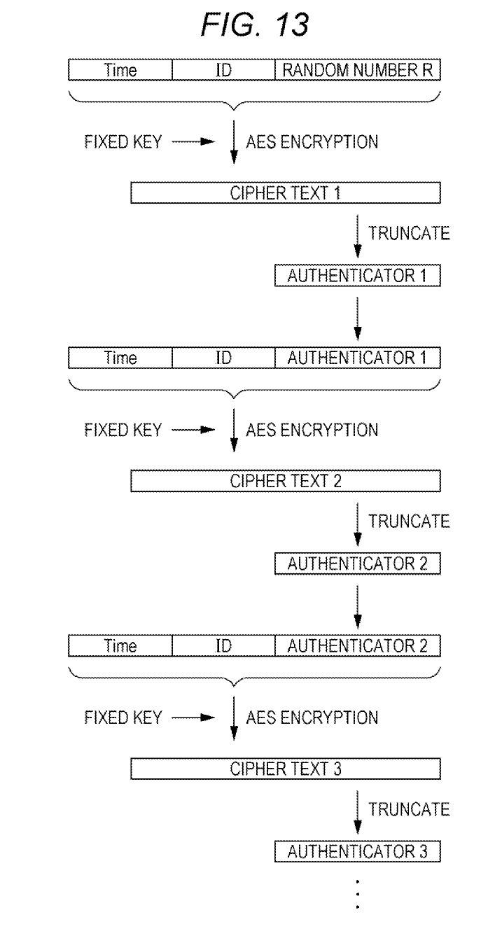

In a second modification, encryption is used instead of Hash. A data encryption system is not limited, but an example where Advanced Encryption Standard (AES) is used will be illustrated. FIG. 13 illustrates a procedure for generating an authenticator according to the second modification. In the generation of an authenticator in the exemplary embodiment (FIG. 3), synthesized data of a time value, an ID, and a random number (or an authenticator) is input into the Hash function. However, in the second modification, the synthesized data is AES-encrypted by using a common fixed key in inspection target ECU 12 and monitoring ECU 14.

A cipher text is truncated so that an authenticator is extracted. For this reason, substantially one-way function is used. For example, it is difficult to estimate authenticator 1 from authenticator 2 in FIG. 13. When a bit number of an authenticator is too small, a brute-force attack in an opposite direction becomes easy. For this reason, a size of the authenticator is preferably half or more of a size of the cipher text before truncation. The time value and the ID in FIG. 13 may be padding data shared between inspection target ECU 12 and monitoring ECU 14 (for example, data of all zero).

Determination unit 38 of monitoring ECU 14 performs AES encryption on data obtained by synthesizing a predetermined time value and ID with an authenticator included in a frame to be inspected, based on the common key with respect to inspection target ECU 12 so as to obtain a cipher text. Determination unit 38 extracts a verification value from the cipher text in accordance with a common truncation rule with respect to inspection target ECU 12. Thereafter, similarly to the exemplary embodiment, determination unit 38 verifies normality of the frame to be inspected in accordance with whether a verification value matches a commitment value.

### (Third Modification)

Although not described in the exemplary embodiment, one inspection target ECU 12 may transmit plural types of normal frames having different IDs. In this case, inspection target ECU 12 may use ECU-ID unique in the self device instead of a frame ID when an authenticator is generated. That is, inspection target ECU 12 may set, in the plural types of normal frames, an authenticator based on the same Hash chain. For example, inspection target ECU 12 may set authenticator (998) in a normal frame having a first frame ID, and may set authenticator (997) which is a base of authenticator (998) in a normal frame having a second frame ID.

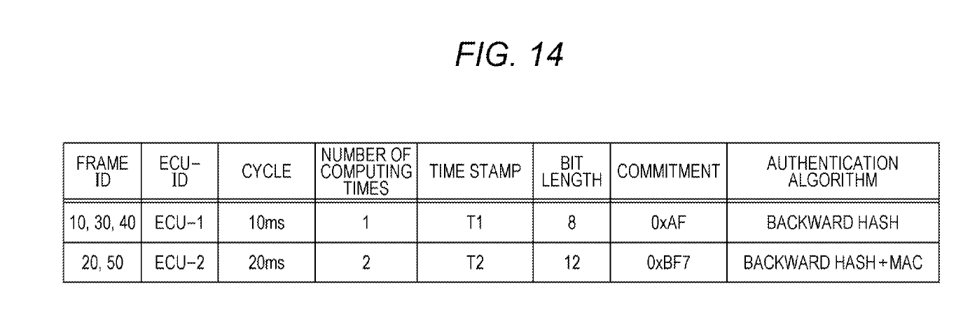

In the third modification, an ECU-ID is set in a commitment registration frame instead of a frame ID of a normal frame. Further, a record in the commitment management table of monitoring ECU 14 is generated for each ECU-ID. Further, monitoring ECU 14 further stores an ID management table in which correspondences between one ECU-ID and one or more frame IDs are defined. The ID management table may be included in the commitment management table. FIG. 14 illustrates the commitment management table according to the third modification. In the table in this diagram, one ECU-ID is associated with a plurality of frame IDs, and a commitment value is managed for each ECU.

A method for creating an ID management table will be described. In method 1, the ID management table may be stored in a storage of monitoring ECU 14 at a time of manufacturing monitoring ECU 14, or may be provided to monitoring ECU 14 from a server on a cloud. In method 2, inspection target ECU 12 may include a correspondence between an ECU-ID and a frame ID in a commitment registration frame. Further, inspection target ECU 12 may transmit a frame dedicated to the correspondence between the ECU-ID and the frame ID to monitoring ECU 14 at a time of registering a commitment.

In method 3, monitoring ECU 14 may have a learning mode as one of operation modes. Inspection target ECU 12 may set an authenticator in plural types of normal frames having different frame IDs based on the same Hash chain and may transmit the plural types of normal frames to monitoring ECU 14. Monitoring ECU 14 performs the Hash operation on an authenticator included in plural types of normal frames received in the learning mode to specify plural types of normal frames in which the authenticator based on the same Hash chain is set. Monitoring ECU 14 may associate a plurality of set frame IDs with the plural types of specified normal frames to record the frame IDs in the ID management table. As a result, the ID management table can be automatically created.

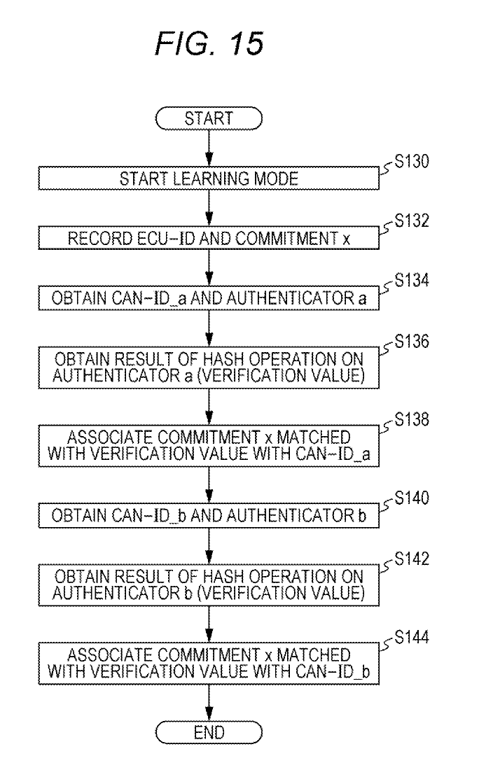

FIG. 15 is a flowchart illustrating the process for automatically creating a commitment management table. Monitoring ECU 14 starts the learning mode when a predetermined condition is satisfied, for example, when the engine is started or the power supply is turned on (S130). Inspection target ECU 12 transmits a commitment registration frame in which the ECU-ID of the self device is associated with a commitment (commitment x) to CAN 16. Monitoring ECU 14 receives the commitment registration frame, and records the ECU-ID and the commitment x set in the commitment registration frame into the commitment management table (S132).

Thereafter, inspection target ECU 12 transmits a normal frame including a CAN-ID (herein, “a”) and an authenticator (herein, an authenticator a which is a source of commitment x) to CAN 16. Monitoring ECU 14 receives the normal frame, and obtains CAN-ID_a and authenticator a set in the normal frame (S134). Monitoring ECU 14 performs the Hash operation on the authenticator a to obtain a verification value (S136). Monitoring ECU 14 updates the commitment management table so that a commitment that matches the verification value (herein, commitment x) is associated with CAN ID_a (S138). Further, monitoring ECU 14 updates commitment x to a value of authenticator a.

Thereafter, inspection target ECU 12 transmits a normal frame including a CAN-ID (herein, “b”) and an authenticator (herein, authenticator b which is a source of authenticator a) to CAN 16. Monitoring ECU 14 receives the normal frame, and obtains CAN-ID_b and authenticator b set in the normal frame (S140). Monitoring ECU 14 performs the Hash operation on authenticator b to obtain a verification value (S142). Monitoring ECU 14 updates the commitment management table so that the commitment which matches the verification value (herein, commitment x) is associated with CAN ID_b (S144). Further, monitoring ECU 14 updates commitment x to a value of authenticator b.

As a result, in the commitment management table, one ECU-ID is associated with CAN-ID_a and CAN-ID_b. Monitoring ECU 14 repeats S132 every time when receiving the commitment registration frame in the learning mode, and repeats S134 to S138 (or S140 to S144) every time when receiving the normal frame. The learning mode may be ended when a predetermined time elapses after the learning mode starts or when an explicit ending instruction is input.

### (Fourth Modification)

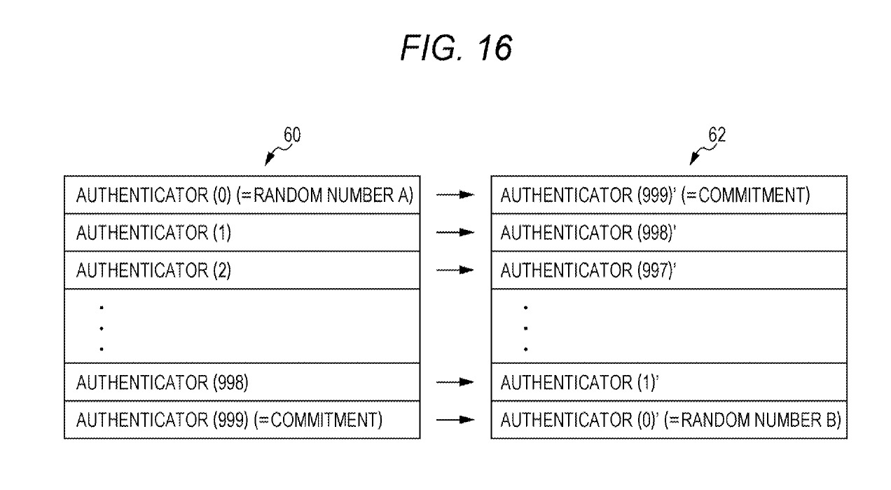

FIG. 16 is a diagram describing duplication of a Hash chain. Hash chain 60 is a Hash chain corresponding to FIG. 4, and a Hash chain including an authenticator which is being currently used. Hash chain 62 is a Hash chain including an authenticator to be used after the authenticator of Hash chain 60. When frame generation unit 28 of inspection target ECU 12 uses a certain authenticator of Hash chain 60 in a normal frame, authenticator generation unit 24 stores new authenticator of Hash chain 62 in an area where the used authenticators are stored (a partial area of commitment storage unit 26).

Specifically, when authenticator (999) of Hash chain 60 is used, authenticator generation unit 24 stores new authenticator (0)∝ of Hash chain 62 in the storage area. Thereafter, when authenticator (998) of Hash chain 60 is used, frame generation unit 28 stores new authenticator (1)∝ of Hash chain 62 in the storage area. That is, authenticator generation unit 24 gradually generates an authenticator of Hash chain 62 every time when the authenticator of Hash chain 60 is used, and records the generated authenticator in commitment storage unit 26. In the present modification, even when inspection target ECU 12 duplicates the Hash chain, it is only necessary that the storage area for authenticator (0) to authenticator (999) be secured, and therefore a necessary storage capacity can be reduced.

### (Fifth Modification)

Inspection target ECU 12 according to the exemplary embodiment entirely stores the plurality of authenticators in the Hash chain into commitment storage unit 26. As a modification, authenticator generation unit 24 of inspection target ECU 12 may generate an authenticator every time when inspection target ECU 12 transmits a frame to monitoring ECU 14. For example, authenticator generation unit 24 may generate authenticator (999) at timing when a commitment registration frame should be transmitted. Further, authenticator generation unit 24 may generate new authenticator (998) at timing when a normal frame should be transmitted next time.

In another modification, commitment storage unit 26 may store some of the plurality of authenticators in the Hash chain in accordance with a predetermined rule. For example, commitment storage unit 26 may store authenticator (0), authenticator (99), authenticator (199), . . . , authenticator (899), and authenticator (999), namely, every 100th authenticator after first authenticator (0). Authenticator generation unit 24 may obtain a stored authenticator which is the closest to an authenticator to be used from stored authenticators which are earlier than the authenticator to be used, and may start the Hash operation on the stored authenticator to generate the authenticator to be used. Any one of the method in the exemplary embodiment and the method described in the fifth modification may be selected in view of a calculation cost and a storage capacity of the storage.

### (Other Modifications)

A plurality of nodes (ECUs or the like) in in-vehicle network system 18 may have a function of monitoring ECU 14 according to the exemplary embodiment and may simultaneously check normality of a frame received from the bus of CAN 16.

Monitoring ECU 14 may be mounted to a dedicated ECU, and may be mounted as a software module.

A bit length of the commitment management table may be estimated based on a transmission cycle of inspection target ECU 12. An example will be described below. 2̂(N−1) operations are necessary in average for cracking N-bit

Hash through brute-force. In accordance with the following estimation, the bit length is determined in view of assumed computing power of an attack ECU.

[8 bits, 10 ms]=>2̂7×100=12800 times/sec.

[12 bits, 20 ms]=>2̂11×50=102400 times/sec.

[16 bits, 10 ms]=>2̂15×100=3276800 times/sec.

When both the Hash chain authentication and the MAC authentication are used, a MAC value is shortened and an authenticator can be made long. Therefore, a length of a MAC value may be determined in accordance with an importance level (criticality) of a frame (a message). The authentication of an N-bit MAC value succeeds only with ½̂N as long as a key is not known. Further, the Hash chain authentication makes the detection of an abnormal state easy. Further, even if the MAC value is shortened, a risk of a leakage of the key does not become high.

Determination unit 38 of monitoring ECU 14 stores an error probability due to a frame collision as a threshold in advance. When the probability that a Hash chain authentication is an error exceeds the threshold, a determination may be made as abnormal.

Inspection target ECU 12 may add at least one of a MAC and a signature to a commitment registration frame. As a result, spoofing can be prevented.

At times of manufacturing inspection target ECU 12 and monitoring ECU 14, the same random number sequence may be saved in them respectively. At a time of first commitment registration from inspection target ECU 12 to monitoring ECU 14, the random number sequence may be set as a value of an old authenticator. As a result, use of a default value “0000...” can be suppressed.

In an environment where a random value generating ability is low, a pseudo random number may be generated by using encryption or Hash. When addition of a new record into the commitment management table is requested, commitment registration unit 32 of monitoring ECU 14 may verify a signature added to the request and may update the commitment management table under condition that the verification succeeds.

In the commitment management table of monitoring ECU 14, both a commitment value based on a current Hash chain (“a new commitment value”) and a commitment value based on a previous Hash chain (“an old commitment value”) may be stored. Determination unit 38 of monitoring ECU 14 may verify an authenticator using both the old and new commitment values until synchronization of commitment updating can be checked.

For example, when receiving a commitment registration frame that requests re-registration of a commitment for a certain frame ID (or an ECU-ID), commitment registration unit 32 of monitoring ECU 14 changes an earlier new commitment value into an old commitment value, and may save a commitment value indicated by the commitment registration frame as a new commitment value. Commitment registration unit 32 may transmit acknowledgment (ACK) data representing completion of the commitment value updating to inspection target ECU 12.

Before reception of the ACK data, inspection target ECU 12 may set, in a normal frame, an authenticator based on a previous Hash chain. After the reception of the ACK data, inspection target ECU 12 may set, in the normal frame, an authenticator based on a current Hush chain. Determination unit 38 of monitoring ECU 14 may use both the new commitment value and the old commitment value after the reception of the ACK data to verify an authenticator of the normal frame. In subsequent verification, determination unit 38 may use only the new commitment value when the verification of the authenticator based on the new commitment value succeeds.

The techniques described in the exemplary embodiment and the modifications can also be applied to communication methods other than the CAN. For example, the techniques can also be applied to an Ethernet (registered trade name), Media Oriented Systems Transport (MOST) (registered trade name), and FlexRay (registered trade name).

The techniques described in the exemplary embodiment and the modifications may also be identified through items described below.

### [Item 1]

A communication system includes a first electronic device connected to a bus network, and a second electronic device that is connected to the bus network and monitors a state of the first electronic device. The first electronic device includes a transmitter that transmits a first frame including a first verification value forming a Hash chain to the bus network. The second electronic device includes a storage unit that stores the first verification value included in the first frame received from the bus network. The transmitter of the first electronic device transmits, after transmission of the first frame, a second frame including a second verification value forming the Hash chain to the bus network. The second electronic device further includes a determination unit that determines that the state of the first electronic device is normal when the second verification value included in the second frame received from the bus network and the first verification value stored in the storage unit construct the Hash chain.

According to the communication system, the second electronic device authenticates validity of a frame transmitted by the first electronic device, based on the Hash chain. This makes it possible to highly accurately discriminate whether a frame which is being sent in the bus network is normal or abnormal without using key information.

### [Item 2]

The transmitter of the first electronic device may transmit the first frame which includes an Nth in the Hash chain as the first verification value, and may transmit the second frame which includes an N−1st value in the Hash chain as the second verification value. N is an integer of 2 or more. The determination unit of the second electronic device may determine that the state of the first electronic device is normal when a result of a Hash operation based on the second verification value included in the second frame matches the first verification value.

According to this aspect, an electronic device that can transmit an appropriate second verification value is only the first electronic device that has constructed the Hash chain, and thus even if an invalid electronic device spoofs the first electronic device, spoofing can be detected. That is, validity of a transmission source of the second frame can be authenticated.

### [Item 3]

The storage unit of the second electronic device may further store a number of operation times according to a number of frames to be discarded by a third electronic device among frames transmitted by the first electronic device. The determination unit of the second electronic device may determine that the state of the first electronic device is normal when a result of performing a Hash operation based on the second verification value included in the second frame at the number of operation times matches the first verification value. According to this aspect, even when the third electronic device, such as a gateway, which relays a frame between different bus networks, deletes a part of a frame transmitted by the first electronic device, validity of the first electronic device can be accurately determined.

### [Item 4]

The transmitter of the first electronic device may transmit the second frame further including a message authentication code. The determination unit of the second electronic device may determine the state of the first electronic device based on both a determination result using the second verification value included in the second frame and a determination result using the message authentication code included in the second frame.

According to this aspect, an increase in a key management cost can be suppressed and simultaneously a security level can be further enhanced by using both authentication based on the Hash chain and authentication based on a message authentication code.

### [Item 5]

A vehicle includes a first electronic device connected to an in-vehicle bus network, and a second electronic device that is connected to the in-vehicle bus network and monitors a state of the first electronic device. The first electronic device includes a transmitter that transmits a first frame including a first verification value forming a Hash chain to the in-vehicle bus network. The second electronic device includes a storage unit that stores the first verification value included in the first frame received from the in-vehicle bus network. The transmitter of the first electronic device transmits, after transmission of the first frame, a second frame including a second verification value forming the Hash chain to the in-vehicle bus network. The second electronic device further includes a determination unit that determines that the state of the first electronic device is normal when the second verification value included in the second frame received from the in-vehicle bus network and the first verification value stored in the storage unit construct the Hash chain.

According to the vehicle, the second electronic device authenticates validity of a frame transmitted by the first electronic device based on the Hash chain. This makes it possible to highly accurately discriminate whether a frame which is being sent in the bus network is normal or abnormal without using key information.

### [Item 6]

A monitoring method includes a first electronic device transmitting a first frame including a first verification value forming a Hash chain to an in-vehicle bus network. The first electronic device is connected to the in-vehicle bus network. Further, the monitoring method includes a second electronic device storing the first verification value included in the first frame received from the in-vehicle bus network into a storage unit. The second electronic device is connected to the in-vehicle bus network and monitors a state of the first electronic device. The monitoring method further includes the first electronic device transmitting, after the transmitting of the first frame, a second frame including a second verification value forming the Hash chain to the in-vehicle bus network. Further, the monitoring method includes the second electronic device determining that the state of the first electronic device is normal when the second verification value included in the second frame received from the in-vehicle bus network and the first verification value stored in the storage unit construct the Hash chain.

According to this monitoring method, the second electronic device authenticates validity of a frame transmitted by the first electronic device based on the Hash chain. This makes it possible to highly accurately discriminate whether a frame which is being sent in the bus network is normal or abnormal without using key information.

Any desired combinations of the above described exemplary embodiment and the above described modifications are also useful as other exemplary embodiments of the present disclosure. Any new exemplary embodiments formed by such combinations include benefits of the exemplary embodiment and the modifications combined into the new exemplary embodiments. It will be understood by those skilled in the art that functions that should be carried out by components described in the appended claims can be achieved by each of or through cooperation of the components illustrated in the exemplary embodiment and the modifications.

The present disclosure relates to a data processing technique, and particularly is useful as a communication system, a vehicle, and a monitoring method.

What is claimed is:

1. A communication system comprising:
a first electronic device connected to a bus network; and
a second electronic device that monitors a state of the first electronic device, the second electronic device connected to the bus network,
wherein the first electronic device includes a transmitter that transmits a first frame including a first verification value forming a Hash chain to the bus network,
the second electronic device includes a storage unit that stores the first verification value included in the first frame received from the bus network,
the transmitter of the first electronic device transmits, after transmission of the first frame, a second frame including a second verification value forming the Hash chain to the bus network, and
the second electronic device further includes a determination unit that determines that the state of the first electronic device is normal when the second verification value included in the second frame received from the bus network and the first verification value stored in the storage unit construct the Hash chain.

2. The communication system according to claim 1, wherein
the transmitter of the first electronic device transmits the first frame which includes an Nth value in the Hash chain as the first verification value, and transmits the second frame which includes an N−1st value in the Hash chain as the second verification value,
N is an integer of 2 or more, and
the determination unit of the second electronic device determines that the state of the first electronic device is normal when a result of a Hash operation based on the second verification value included in the second frame matches the first verification value.

3. The communication system according to claim 1, wherein
the storage unit of the second electronic device further stores a number of operation times according to a number of frames to be discarded by a third electronic device among frames transmitted by the first electronic device, and
the determination unit of the second electronic device determines that the state of the first electronic device is normal when a result of performing a Hash operation based on the second verification value included in the second frame at the number of operation times matches the first verification value.

4. The communication system according to claim 1, wherein
the transmitter of the first electronic device transmits the second frame further including a message authentication code, and
the determination unit of the second electronic device determines the state of the first electronic device based on both a determination result using the second verification value included in the second frame and a determination result using the message authentication code included in the second frame.

5. A vehicle comprising:
a main body;
a driver that moves the main body;
an in-vehicle bus network;
a first electronic device connected to the in-vehicle bus network; and
a second electronic device that monitors a state of the first electronic device, the second electronic device connected to the in-vehicle bus network,
wherein the first electronic device includes a transmitter that transmits a first frame including a first verification value forming a Hash chain to the in-vehicle bus network,
the second electronic device includes a storage unit that stores the first verification value included in the first frame received from the in-vehicle bus network,
the transmitter of the first electronic device transmits, after transmission of the first frame, a second frame including a second verification value forming the Hash chain to the in-vehicle bus network, and
the second electronic device further includes a determination unit that determines that the state of the first electronic device is normal when the second verification value included in the second frame received from the in-vehicle bus network and the first verification value stored in the storage unit construct the Hash chain.

6. A monitoring method comprising:
a first electronic device transmitting a first frame including a first verification value forming a Hash chain to an in-vehicle bus network, the first electronic device being connected to the in-vehicle bus network;
a second electronic device storing the first verification value included in the first frame received from the in-vehicle bus network into a storage unit, the second electronic device being connected to the in-vehicle bus network and monitoring a state of the first electronic device;
the first electronic device transmitting, after the transmitting of the first frame, a second frame including a second verification value forming the Hash chain to the in-vehicle bus network; and
the second electronic device determining that the state of the first electronic device is normal when the second verification value included in the second frame received from the in-vehicle bus network and the first verification value stored in the storage unit construct the Hash chain.
